(19) United States
(12) Patent Application Publication
(10) Pub. No.: US 2025/0259364 A1
(43) Pub. Date: Aug. 14, 2025

(54) METHOD AND DEVICE FOR CONTROLLING MOTION OF VIRTUAL OBJECT

(71) Applicant: Beijing Zitiao Network Technology Co., Ltd., Haidian District, Beijing (CN)

(72) Inventor: Yixin Chen, Beijing (CN)

(21) Appl. No.: 18/858,200

(22) PCT Filed: Mar. 31, 2023
(86) PCT No.: PCT/CN2023/085722

§ 371 Date: Oct. 18, 2024

(30) Foreign Application Priority Data
Apr. 19, 2022 (CN) 202210411519.3

(51) Int. Cl. G06T 13/40; A63F 13/55; G06T 19/20

(52) U.S. Cl. CPC G06T 13/40; A63F 13/55; G06T 19/20; G06T 2219/2016

(57) ABSTRACT

There are provided a method and device for controlling motion of a virtual object, which relate to the technical field of motion control. In the method a rotation control vector is generated according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; Motion of the virtual object is controlled through the rotation control vector, the motion comprising rotational motion. The methods and devices of the present disclosure can improve the experience of motion control on the virtual object.

### CROSS REFERENCE TO RELATED APPLICATIONS

This application claims priority to Chinese Patent Application No. 202210411519.3, filed with the Chinese Patent Office on Apr. 19, 2022, and entitled “METHOD AND DEVICE FOR CONTROLLING MOTION OF VIRTUAL OBJECT”, the disclosures of which are incorporated herein by reference in their entities.

### FIELD

Embodiments of the present disclosure relate to the technical field of motion control, and in particular, to a method and device for controlling motion of a virtual object.

### BACKGROUND

In the technical field of motion control, a virtual object can move continuously in a display interface, and the movement of the virtual object can be controlled by a user. The user may control the virtual object through a keyboard or a mouse, and may also control the virtual object through a face.

In the prior art, while a user controls a virtual object to move, a movement process of the virtual object may be displayed in a display interface. With reference to FIG. 1, a virtual object is located at a position L1 of a display interface at a time t1, and after movement, arrives at a position L2 at a time t2, arrives at a position L3 at a time t3, arrives at a position L4 at a time t4, and arrives at a position 5 at a time t5 in sequence. Thus, a movement path from L1 to L5 is formed, and certainly, at a time, the display interface only displays the position of the virtual object at the current moment.

However, the control experience in the prior art is poor.

### SUMMARY

Embodiments of the present disclosure provide a method and device for controlling motion of a virtual object, which can control the rotation of the virtual object so as to improve the control experience.

According to a first aspect, an embodiment of the present disclosure provides a method for controlling motion of a virtual object, comprising:
generating a rotation control vector according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; and
controlling motion of the virtual object through the rotation control vector, the motion comprising rotational motion.

According to a second aspect, an embodiment of the present disclosure provides an apparatus for controlling motion of a virtual object, comprising:
a control vector generating module configured to generate a rotation control vector according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; and
a motion control module configured to control motion of the virtual object through the rotation control vector, the motion comprising rotational motion.

According to a third aspect, an embodiment of the present disclosure provides an electronic device, comprising: at least one processor and a memory;
the memory storing computer-executed instructions;
the at least one processor executing the computer-executed instructions stored in the memory to cause the electronic device to implement the method according to the first aspect.

According to a fourth aspect, an embodiment of the present disclosure provides a computer readable storage medium, storing computer-executed instructions thereon. The computer-executed instructions, when executed by a processor, cause a computing device to implement the method according to the first aspect.

According to a fifth aspect, an embodiment of the present disclosure provides a computer program for implementing the method according to the first aspect.

According to a sixth aspect, an embodiment of the present disclosure provides a computer program product, comprising a computer program for implementing the method according to the first aspect.

### BRIEF DESCRIPTION OF THE DRAWINGS

To describe the technical solutions in the embodiments of the present disclosure or in the prior art more clearly, a brief introduction is presented below to the accompanying drawings to be used in the description of the embodiments or the prior art, Apparently, the accompanying drawings in the following description show some embodiments of the present disclosure, and for those skilled in the art, they may further derive other drawings according to these drawings without creative efforts.

FIG. 1 is a schematic diagram of a motion process of a virtual object in the prior art;

FIG. 2 is a flowchart of steps of a method for controlling motion of a virtual object according to an embodiment of the present disclosure;

FIG. 3 is a schematic diagram of a rotation angle of a face according to an embodiment of the present disclosure;

FIG. 4 is a structural block diagram of an apparatus for controlling motion of a virtual object according to an embodiment of the present disclosure;

FIG. 5 is a structural block diagram of one electronic device according to an embodiment of the present disclosure; and

FIG. 6 is a block diagram of another electronic device according to an embodiment of the present disclosure.

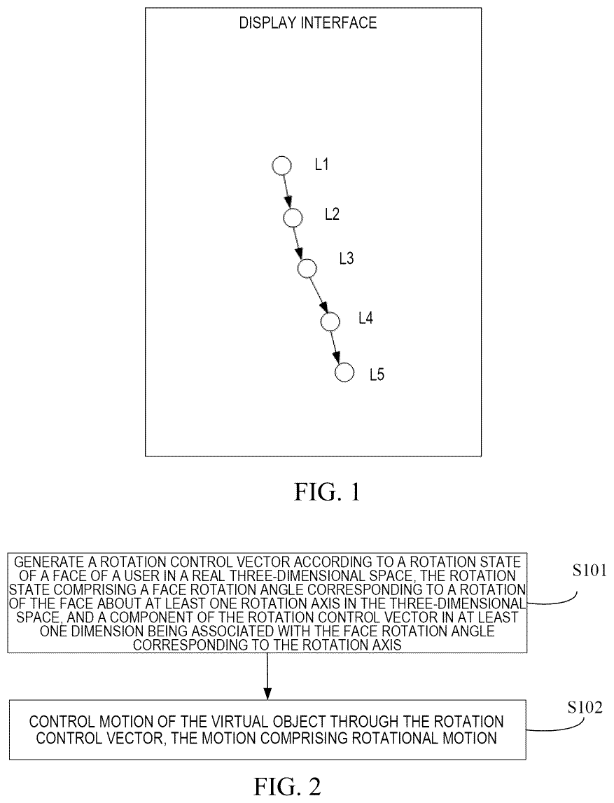

### DETAILED DESCRIPTION

In order to make objects, technical solutions and advantages of the embodiments of the present disclosure more apparent, a clear and complete description is presented below to the technical solutions in the embodiments of the present disclosure in conjunction with the accompanying drawings in the embodiments. Obviously, the embodiments to be described are only a part but not all of the embodiments of the present disclosure. All other embodiments obtained by those of ordinary skill in the art based on the embodiments of the present disclosure without creative efforts shall belong to the protection scope of the present disclosure.

As described in the background, the control experience in the prior art is poor. In order to solve the foregoing technical problem, the inventor has found, after analyzing the problem, that one of the causes of the foregoing problem is that a virtual object in the prior art generally performs a translational motion, resulting in poor control experience.

To solve the foregoing technical problem, the embodiments of the present disclosure can consider controlling a virtual object to make rotational motion so as to improve the control experience.

With reference to specific embodiments, a detailed description is presented below to the technical solutions of the embodiments of the present disclosure and how to solve the above technical problem by the technical solutions of the present disclosure. The following several specific embodiments may be combined with each other, and the same or similar concepts or procedures may not be repeated in certain embodiments. Embodiments of the present disclosure will be described below with reference to the accompanying drawings.

FIG. 2 is a flowchart of steps of a method for controlling motion of a virtual object provided by an embodiment of the present disclosure. The virtual object herein may be any object displayed on a display screen of the electronic device, and in different application scenarios, the virtual objects are different. An application scenario of the embodiments of the present disclosure is a game scenario. In the game scenario, a game interface may be displayed on a display screen, and the virtual object may be understood as a game character that may move in the game interface. The motion can be controlled by a game player. It should be noted that the application scenario of the embodiments of the present disclosure is not limited to the game scenario, and thus the virtual object is not limited to the game character.

With reference to FIG. 2, the method for controlling motion of a virtual object comprises:
S101: generating a rotation control vector according to a rotation state of a face of a user in a real three-dimensional space, the rotation state comprises: a face rotation angle corresponding to a rotation of the face about at least one rotation axis in the three-dimensional space, and a component of the rotation control vector in at least one dimension is associated with the face rotation angle corresponding to the rotation axis.

Herein, the face rotation angle may be a vector for representing a direction and an amplitude. In practical applications, a plurality of rotation axes located in the real three-dimensional space may be set, so that one face rotation angle is a rotation angle for one rotation axis. Here, the rotation axis can be set at random, but considering as few rotation axes as possible to represent rotation in various directions, three rotation axes perpendicular to each other may be set.

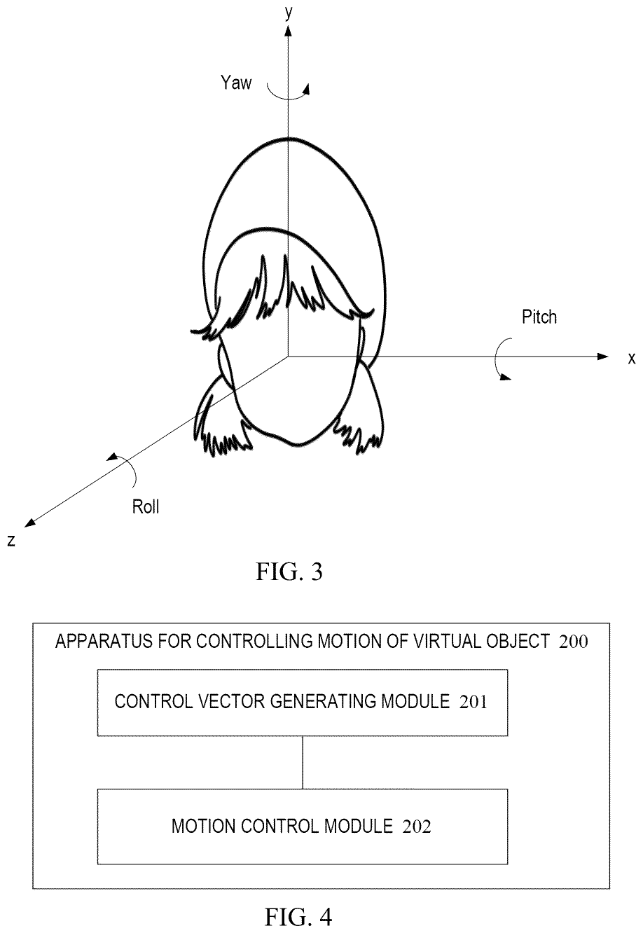

FIG. 3 is a schematic diagram of a face rotation angle provided by an embodiment of the present disclosure. With reference to FIG. 3, three coordinate axes: an x axis, a y axis, and a z axis may serve as one rotation axis respectively. Thus, the rotation state of the face may include a face rotation angle Pitch by which the face rotates about the x-axis, a face rotation angle Yaw by which the face rotates about the y-axis, and a face rotation angle Roll by which the face rotates about the z-axis.

Pitch may also be understood as a rotation angle of the face in the YOZ plane formed by the y-axis and the z-axis, Yaw may also be understood as the rotation angle of the face in the XOZ plane formed by the x-axis and the z-axis, and Roll may also be understood as the rotation angle of the face in the XOY plane formed by the x-axis and the y-axis.

The rotation control vector may be a three-dimensional vector, and an association between its component in each dimension and the face rotation angle may be flexibly set. For example, at least one face rotation angle may be respectively used as a component of the rotation control vector in at least one dimension, or the face rotation angle may be used as after linear or non-linear conversion.

It should be noted that, when a face rotation angle is used as a component of the rotation control vector, the user may rotate the face about a corresponding rotation axis, so as to implement motion control of the virtual object. When a plurality of face rotation angles are used as a plurality of components of the rotation control vector, the motion control of the virtual object can be realized by the rotation of the face about a plurality of rotation axes, which helps to improve the diversity of the rotational motion and further improves the fun of the game.

Optionally, mapping a face rotation angle to a component of a rotation control vector may be implemented by the following steps: first, obtaining a face rotation angle respectively corresponding to a first rotation axis and a second rotation axis, the first rotation axis being a rotation axis located on a horizontal plane and parallel to a screen, and the second rotation axis being a rotation axis located in a vertical direction; then, determining a component of the rotation control vector in a third dimension according to the face rotation angle corresponding to the first rotation axis; further, determining the face rotation angle corresponding to the second rotation axis as a component of the rotation control vector in a first dimension; finally, setting a component of the rotation control vector in a second dimension to zero.

Herein, the first rotation axis may be the x axis in FIG. 3, and the second rotation axis may be the y axis in FIG. 3.

In a first aspect, with reference to FIG. 3, the embodiment of the present disclosure may map Pitch to the component of the rotation control vector in the third dimension, so that the user controls a rotation angle of the virtual object in the third dimension of the three-dimensional space thereof and controls translational motion of the virtual object in the third dimension of the three-dimensional space thereof by flipping the angle (Pitch) of the face up and down. The third dimension may be a dimension in a vertical direction.

In a second aspect, with reference to FIG. 3, the embodiment of the present disclosure may map Yaw to the component of the rotation control vector in the first dimension, so that the user controls a rotation angle of the virtual object in the first dimension of the three-dimensional space thereof and controls translational motion of the virtual object in the first dimension of the three-dimensional space thereof by flipping the angle Yaw of the face left and right. The first dimension may be a dimension in a horizontal direction.

In a third aspect, the embodiment of the present disclosure sets the component of the rotation control vector in the second dimension to 0, so that the virtual object does not rotate in the second dimension of the three-dimensional space and does not perform the translational motion. The second dimension may be a dimension perpendicular to the screen.

It will be appreciated that, from a top view perspective, the motion of the virtual object in a plane formed in the first and third dimensions has a better display effect, while the motion in the second dimension has no good display effect. Thus, in the embodiments of the present disclosure, the rotation control vector in the second dimension is set to 0 by the above method, so as to reduce the calculation complexity as much as possible.

In a first example of the embodiment of the present disclosure, considering that the virtual object and the user are in a mirror relationship, the component of the rotation control vector in the third dimension is determined to be the opposite number of the face rotation angle corresponding to the first rotation axis. When the user flips the face upward, the virtual object can be ensured to perform translational motion upward, and similarly, when the user flips the face downward, the virtual object can be ensured to perform translational motion downward. In this way, the consistency between the motion of the user and the motion of the virtual object can be guaranteed, and the accuracy of controlling the virtual object by the user can be improved.

In a second example of the embodiment of the present disclosure, in order to adjust the control sensitivity in the third dimension, a component of the rotation control vector in the third dimension may be determined according to a first predetermined coefficient and the opposite number of the face rotation angle corresponding to the first rotation axis, where the first predetermined coefficient is used to adjust the control sensitivity in the third dimension.

Herein, the component of the rotation control vector in the third dimension may be a product of the first predetermined coefficient and the foregoing opposite number.

It may be understood that, when the first predetermined coefficient is greater than 1, the user can control the motion of the virtual object by flipping up and down the face with a smaller amplitude, which helps to improve the control sensitivity in the third dimension. When the first predetermined coefficient is less than 1, the user can control the motion of the virtual object by flipping up and down a face with a larger amplitude, so as to avoid mis-operation of the user by reducing the sensitivity.

In a third example of the embodiment of the present disclosure, in order to flexibly adapt to people's habit of flipping the face up and down, the angle Pitch of flipping up and down may be corrected. Specifically, a sum of the face rotation angle corresponding to the first rotation axis and a second predetermined coefficient is first determined as a correction angle, and then a product of the opposite number of the correction angle and the first predetermined coefficient is determined as the component of the rotation control vector in the third dimension.

Herein, the second predetermined coefficient may be flexibly set, and may be greater or less than 0.

When the second predetermined coefficient is greater than 0, with reference to the coordinate system shown in FIG. 3, the up-and-down flipping angle may be corrected downward. Thus, if a person is accustomed to flipping upward, the up-and-down flipping angle may be corrected downward appropriately, so as to perform motion control on various rotation axes for a virtual object. If a person is accustomed to flipping upward, the up-and-down flipping angle can be corrected downward appropriately, so that when the user flips upward with a small amplitude, the virtual object is controlled to perform translational motion downward. In scenarios in which the user is accustomed to flipping the face upward, it is beneficial to improving the motion diversity of the virtual object.

When the second predetermined coefficient is less than 0, with reference to the coordinate system shown in FIG. 3, the up-and-down flipping angle may be corrected upward. Thus, if a person is accustomed to flipping down, the up-and-down flipping angle can be appropriately corrected upward, so that when the user flips down to a small extent, the virtual object is controlled to perform translational motion upward. In scenarios in which the user is accustomed to flipping the face downward, it is beneficial to improving the motion diversity of the virtual object.

S102: controlling motion of the virtual object through the rotation control vector, the motion comprising rotational motion.

Compared with the translational motion, the rotational motion of the embodiment of the present disclosure can provide a better control experience for the user. Compared with the translational motion, the rotational motion has a better display effect in a top view angle, thereby improving the control experience in the top view angle.

In an example of the embodiments of the present disclosure, the virtual object may be controlled to perform rotational motion according to a direction to which the rotation control vector points, and the rotation control vector may be a three-dimensional vector, so that a component in each dimension is used to indicate a rotation direction and a rotation angle on a corresponding rotation axis.

In another example of the embodiments of the present disclosure, the virtual object may be controlled to perform rotational motion through a first rotation parameter corresponding to the rotation control vector. Specifically, the following steps 1021 to 1024 may be included:

S1021, converting the rotation control vector into a first rotation parameter, the first rotation parameter being used for representing a rotation policy through a predetermined number of first sub-parameters, and the predetermined number being greater than the number of dimensions of the rotation control vector.

It can be seen that, compared with the rotation control vector, the first rotation parameter may use more first sub-parameters to represent the rotation policy, which helps to improve the accuracy of the rotation policy.

Herein, the first rotation parameter may be a quaternion corresponding to the rotation control vector, and each three-dimensional vector corresponds to a unique quaternion.

S1022, obtaining a second rotation parameter of the virtual object, the second rotation parameter being used for representing a current orientation of the virtual object through the predetermined number of second sub-parameters.

Corresponding to the first rotation parameter, the second rotation parameter may also represent the current orientation with more second sub-parameters, thereby helping to improve the accuracy of the current orientation.

Herein, the second rotation parameter may be a quaternion, and an obtaining process thereof may comprise: firstly, obtaining a three-dimensional vector corresponding to a current orientation of the virtual object as an orientation vector of the virtual object, and then converting the orientation vector into a quaternion to obtain the second rotation parameter.

S1023, determining a first angle between the first rotation parameter and the second rotation parameter.

Herein, the first angle may also be understood as the degree of an included angle between the rotation control vector and the orientation vector of the virtual object. When the first rotation parameter and the second rotation parameter are quaternions, the first angle is an angle between the two quaternions.

S1024, controlling the virtual object to perform rotational motion through the first angle.

Optionally, when both the first rotation parameter and the second rotation parameter are quaternions, S1024 may specifically comprise: firstly, determining a minimum value of the first angle and a maximum character rotation angle between two adjacent frame images as a second angle; then performing an interpolation operation on the first rotation parameter and the second rotation parameter by using the second angle, to obtain a corresponding third quaternion; and finally, controlling the virtual object to perform rotational motion through the third quaternion.

Herein, the maximum character rotation angle may be a product of a predetermined rotation angle and a time interval between two adjacent frame images, and the predetermined rotation angle may be set according to an actual application scenario.

It can be seen that, when the first angle is greater than the maximum character rotation angle, the third quaternion corresponds to the maximum character rotation angle, so that the rotational motion of the virtual object is realized according to the maximum character rotation angle. When the first angle is less than the maximum character rotation angle, the third quaternion corresponds to the first angle, so that the rotational motion of the virtual object is realized according to the first angle. That is, in the embodiment of the present disclosure, the rotation degree of the virtual object is at most the maximum character rotation angle, so that the phenomenon of discontinuous pictures caused by excessive rotation of the virtual object can be avoided.

In addition, in the embodiments of the present disclosure, the rotational motion can be achieved by the quaternion, which helps to avoid the problem of deadlocked universal joints.

Optionally, the motion can further include translational motion. In the embodiments of the present disclosure, the virtual object can be controlled to perform translational motion by using the rotation control vector, Thus, the motion of the virtual object in the embodiments of the present disclosure is the superposition of the rotational motion and the translational motion, so that the user can see the rotational motion and the translational motion of the virtual object in a top view angle, which helps to further improve the game experience of the virtual object in a top view angle.

Specifically, when performing the above translational motion, a motion vector of the virtual object is determined according to the rotation control vector and a current motion velocity of the virtual object, and then a position of the virtual object after translational motion is determined through the motion vector, so as to display the virtual object at the position.

Herein, the rotation control vector, the current motion velocity, and the motion vector are all three-dimensional vectors. The motion vector may be a cross product between the rotation control vector and the current motion velocity, or may be referred to as an outer product.

After the motion vector is obtained, a current position of the virtual object and the motion vector may be added to obtain a position after translational motion. The position here is a position in a three-dimensional coordinate system.

It should be noted that the translational motion in the embodiments of the present disclosure is controlled by the rotation of the face, the mapping relationship between the face rotation angle and the rotation control vector may affect the correspondence relationship between the rotation of the face and the translational motion, and the translational motion may be flexibly adjusted by setting the mapping relationship.

Optionally, before the virtual object is controlled to perform the foregoing motion, it may further be judged whether a modulus of the rotation control vector is greater than or equal to a predetermined threshold. If the modulus of the rotation control vector is greater than or equal to the predetermined threshold, the virtual object is controlled to perform the foregoing motion by using the rotation control vector. If the modulus of the rotation control vector is less than the predetermined threshold, the virtual object is controlled to maintain the current position and the current state, that is, the virtual object is controlled not to perform the foregoing motion.

It can be seen that, in the embodiments of the present disclosure, for a large rotation amplitude, the face rotation may be determined as a control instruction of the user for the virtual object, so as to control the motion of the virtual object. When the face rotates at a small amplitude, the face rotation is determined as a mis-operation of the user, at which point, the virtual object is controlled not to move. In this way, the user's mis-operation can be avoided, and the accuracy of motion control of the virtual object is improved.

Optionally, after the rotation control vector is obtained, unitized processing may be performed on the rotation control vector, and the motion of the virtual object is controlled by using the rotation control vector obtained through the unitized processing. In this way, the computational complexity in controlling the motion of the virtual object by the rotation control vector can be reduced.

Herein, the unitized processing may also be referred to as normalization processing, and specifically comprises the following steps: first, determining a modulus of the rotation control vector; then, calculating a ratio of the rotation control vector to the modulus to obtain the rotation control vector after the unitized processing.

It should be noted that the unitized processing may also be combined with the judgment of the modulus. Specifically, if the modulus of the rotation control vector is greater than or equal to a predetermined threshold, the rotation control vector is first subjected to unitized processing, and the motion of the virtual object is controlled by means of the rotation control vector after the unitized processing. If the modulus of the rotation control vector is less than the predetermined threshold, the virtual object is controlled to maintain the current position and current state, that is, the virtual object is controlled not to move.

Corresponding to the method for controlling motion of a virtual object in the above embodiments, FIG. 4 is a structural block diagram of an apparatus for controlling motion of a virtual object provided by an embodiment of the present disclosure. For the sake of description, only parts related to the embodiment of the present disclosure are shown. Referring to FIG. 4, an apparatus 200 for controlling motion of a virtual object comprises a control vector generating module 201 and a motion control module 202.

Herein, the control vector generating module 201 is configured to generate a rotation control vector according to a rotation state of a face of a user in a real three-dimensional space, the rotation state comprises a face rotation angle corresponding to respective rotation of the face about at least one rotation axis in the three-dimensional space, and a component of the rotation control vector in at least one dimension is associated with the face rotation angle corresponding to the rotation axis.

The motion control module 202 is configured to control motion of the virtual object through the rotation control vector, the motion comprises rotational motion.

Optionally, the motion control module 202 is further configured to:
convert the rotation control vector into a first rotation parameter, the first rotation parameter is used for representing a rotation policy through a predetermined number of first sub-parameters, and the predetermined number is greater than the number of dimensions of the rotation control vector.
obtain a second rotation parameter of the virtual object, the second rotation parameter is used for representing a current orientation of the virtual object by means of the predetermined number of second sub-parameters;
determine a first angle between the first rotation parameter and the second rotation parameter; and
control the virtual object to perform rotational motion through the first angle.

Optionally, both the first rotation parameter and the second rotation parameter are quaternions.

Optionally, the motion control module 202 is further configured to:
determine a minimum value of the first angle and a maximum character rotation angle between two adjacent frame images as a second angle;
perform an interpolation operation on the first quaternion and the second quaternion through the second angle, to obtain a corresponding third quaternion; and
control the virtual object to perform rotational motion through the third quaternion.

Optionally, the motion control module 202 is further configured to:
in response to that a modulus of the rotation control vector is greater than or equal to a predetermined threshold, control motion of the virtual object through the rotation control vector.

Optionally, the motion control module 202 is further configured to:
perform unitized processing on the rotation control vector, and control motion of the virtual object through the rotation control vector after the unitized processing.

Optionally, the control vector generating module 201 is further configured to:
obtain a face rotation angle corresponding to the first rotation axis and the second rotation axis respectively, the first rotation axis is a rotation axis located on a horizontal plane and parallel to a screen, and the second rotation axis is a rotation axis located in a vertical direction;
determine a component of the rotation control vector in a third dimension according to the face rotation angle corresponding to the first rotation axis, the third dimension is in a vertical direction;
determine the face rotation angle corresponding to the second rotation axis as a component of the rotation control vector in a first dimension, the first dimension is in a horizontal direction; and set a component of the rotation control vector in a second dimension to zero.

Optionally, the control vector generating module 201 is further configured to:
determine a component of the rotation control vector in a third dimension according to an opposite number of the face rotation angle corresponding to the first rotation axis.

Optionally, the control vector generating module 201 is further configured to:
determine a component of the rotation control vector in a third dimension through a first predetermined coefficient and an opposite number of the face rotation angle corresponding to the first rotation axis, the first predetermined coefficient is used to adjust the control sensitivity in the third dimension.

Optionally, the control vector generating module 201 is further configured to:
determine a sum of the face rotation angle corresponding to the first rotation axis and a second predetermined coefficient as a correction angle; and
determine a product of an opposite number of the correction angle and the first predetermined coefficient as a component of the rotation control vector in a third dimension.

Optionally, the motion further comprises translational motion, and the motion control module 202 is further configured to:
determine a motion vector of the virtual object according to the rotation control vector and a current motion velocity of the virtual object; and
determine a position of the virtual object after the translational motion through the motion vector.

The apparatus for controlling motion of a virtual object provided in this embodiment may be used to perform the technical solution of the method embodiment shown in FIG. 2, with similar implementation principles and technical effects, which are not repeated here.

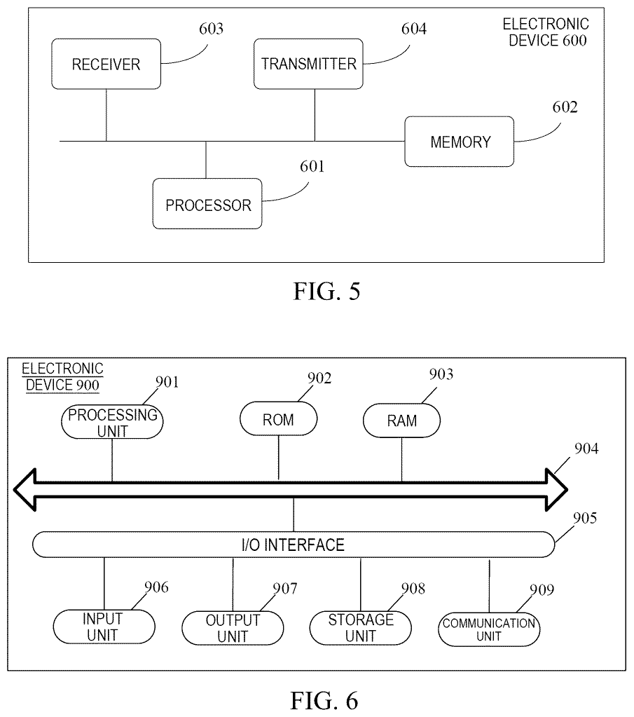

FIG. 5 is a structural block diagram of an electronic device 600 provided by an embodiment of the present disclosure. The electronic device 600 comprises a memory 602 and at least one processor 601.

Herein, the memory 602 stores computer-executed instructions.

The at least one processor 601 executes the computer-executed instructions stored in the memory 602 to cause the electronic device 600 to implement the foregoing method in FIG. 2.

In addition, the electronic device can further include a receiver 603 and a transmitter 604, where the receiver 603 is configured to receive information from other apparatuses or devices and forward the information to the processor 601, and the transmitter 604 is configured to send the information to the other apparatuses or devices.

Further, with reference to FIG. 6, this figure shows a structural schematic diagram of an electronic device 900 which is applicable to implement the embodiments of the present disclosure. The electronic device 900 may be a terminal device. The terminal device may include, without limitation to, a mobile terminal such as a mobile phone, a notebook computer, a digital broadcast receiver, a personal digital assistant (PDA), a portable Android device (PAD), a portable multimedia player (PMP), an on-board terminal (e.g., an on-board navigation terminal) and the like, as well as a fixed terminal such as digital TV, a desktop computer and the like. The electronic device shown in FIG. 6 is merely an example and should not be construed as bringing any restriction on the functionality and usage scope of the embodiments of the present disclosure.

As shown in FIG. 6, the electronic device 900 may comprise a processing unit (e.g., a central processor, a graphics processor) 901 which is capable of performing various appropriate actions and processes to realize the method of table processing as described in the embodiments of the present disclosure in accordance with programs stored in a read only memory (ROM) 902 or programs loaded from a storage unit 908 to a random access memory (RAM) 903. In the RAM 903, there are also stored various programs and data required by the electronic device 900 when operating. The processing unit 901, the ROM 902 and the RAM 903 are connected to one another via a bus 904. An input/output (I/O) interface 905 is also connected to the bus 904.

Usually, the following units may be connected to the I/O interface 905: an input unit 906 including a touch screen, a touch pad, a keyboard, a mouse, a camera, a microphone, an accelerometers, a gyroscope, or the like; an output unit 907, such as a liquid-crystal display (LCD), a loudspeaker, a vibrator, or the like; a storage unit 908, such as a magnetic tape, a hard disk or the like; and a communication unit 909. The communication unit 909 allows the electronic device 900 to perform wireless or wired communication with other device so as to exchange data with other device. While FIG. 6 shows the electronic device 900 with various units, it should be understood that it is not required to implement or have all of the illustrated units. Alternatively, more or less units may be implemented or exist.

Specifically, according to the embodiments of the present disclosure, the procedures described with reference to the flowchart may be implemented as computer software programs. For example, the embodiments of the present disclosure comprise a computer program product that comprises a computer program embodied on a non-transitory computer-readable medium, the computer program including program codes for executing the method shown in the flowchart. In such an embodiment, the computer program may be loaded and installed from a network via the communication unit 909, or installed from the storage unit 908, or installed from the ROM 902. The computer program, when executed by the processing unit 901, perform the above functions defined in the method of the embodiments of the present disclosure.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

The above computer readable medium may be included in the above-mentioned electronic device; and it may also exist alone without being assembled into the electronic device.

The computer readable medium carries one or more programs which, when executed by the electronic device, cause the electronic device to perform the method described in the above embodiments.

Computer program codes for carrying out operations of the present disclosure may be written in one or more programming languages, including without limitation to, an object oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units described in the embodiments of the present disclosure may be implemented as software or hardware, where the name of a unit does not form any limitation to the unit per se in some case. For example, the first obtaining unit may be further described as a “unit configured to obtain at least two Internet protocol addresses”.

The functions described above may be executed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In the context of the present disclosure, the machine readable medium may be a tangible medium, which may include or store a program used by an instruction executing system, apparatus or device or used in conjunction with the foregoing. The machine readable medium may be a machine readable signal medium or a machine readable storage medium. The machine readable medium may include, but is not limited to, an electronic, magnetic, optical, electromagnetic, infrared, semiconductor system, means or device, or any suitable combination of the foregoing. More specific examples of the machine readable storage medium include the following: an electric connection with one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In a first example according to a first aspect, an embodiment of the present disclosure provides a method for controlling motion of a virtual object, comprising:
generating a rotation control vector according to a rotation state of a face of a user in a real three-dimensional space, the rotation state comprises a face rotation angle corresponding to a rotation of the face about at least one rotation axis in the three-dimensional space, and a component of the rotation control vector in at least one dimension is associated with the face rotation angle corresponding to the rotation axis; and
controlling motion of the virtual object through the rotation control vector, the motion comprises rotational motion.

Based on the first example according to the first aspect, in a second example according to the first aspect, controlling motion of the virtual object through the rotation control vector comprises:
converting the rotation control vector into a first rotation parameter, the first rotation parameter is used for representing a rotation policy through a predetermined number of first sub-parameters, and the predetermined number is greater than the number of dimensions of the rotation control vector;
obtaining a second rotation parameter of the virtual object, the second rotation parameter is used for representing a current orientation of the virtual object by means of the predetermined number of second sub-parameters;
determining a first angle between the first rotation parameter and the second rotation parameter; and
controlling the virtual object to perform rotational motion through the first angle.

Based on the second example according to the first aspect, in a third example according to the first aspect, both the first rotation parameter and the second rotation parameter are quaternions.

Based on the third example according to the first aspect, in a fourth example according to the first aspect, controlling the virtual object to perform rotational motion through the first angle comprises:
determining a minimum value of the first angle and a maximum character rotation angle between two adjacent frame images as a second angle;
performing an interpolation operation on the first quaternion and the second quaternion through the second angle, to obtain a corresponding third quaternion; and
controlling the virtual object to perform rotational motion through the third quaternion.

Based on the first to fourth examples according to the first aspect, in a fifth example according to the first aspect, controlling motion of the virtual object through the rotation control vector comprises:
in response to a determination that a modulus of the rotation control vector is greater than or equal to a predetermined threshold, controlling motion of the virtual object through the rotation control vector.

Based on the fifth example according to the first aspect, in a sixth example according to the first aspect, controlling motion of the virtual object through the rotation control vector comprises:
performing unitized processing on the rotation control vector, and controlling motion of the virtual object through the rotation control vector after the unitized processing.

Based on the first to fourth examples according to the first aspect, in a seventh example according to the first aspect, generating a rotation control vector according to a rotation state of a face of a user in a real three-dimensional space comprises:
obtaining a face rotation angle corresponding to the first rotation axis and the second rotation axis respectively, the first rotation axis is a rotation axis located on a horizontal plane and parallel to a screen, and the second rotation axis is a rotation axis located in a vertical direction;
determining a component of the rotation control vector in a third dimension according to the face rotation angle corresponding to the first rotation axis, the third dimension is in a vertical direction;
determining the face rotation angle corresponding to the second rotation axis as a component of the rotation control vector in a first dimension, the first dimension is in a horizontal direction; and
setting a component of the rotation control vector in a second dimension to zero.

Based on the seventh example according to the first aspect, in an eighth example according to the first aspect, determining a component of the rotation control vector in a third dimension according to the face rotation angle corresponding to the first rotation axis comprises:
determining a component of the rotation control vector in a third dimension according to an opposite number of the face rotation angle corresponding to the first rotation axis.

Based on the eighth example according to the first aspect, in a ninth example according to the first aspect, determining a component of the rotation control vector in a third dimension according to an opposite number of the face rotation angle corresponding to the first rotation axis comprises:
determining a component of the rotation control vector in a third dimension through a first predetermined coefficient and an opposite number of the face rotation angle corresponding to the first rotation axis, the first predetermined coefficient is used to adjust the control sensitivity in the third dimension.

Based on the ninth example according to the first aspect, in a tenth example according to the first aspect, determining a component of the rotation control vector in a third dimension through a first predetermined coefficient and an opposite number of the face rotation angle corresponding to the first rotation axis comprises:
determining a sum of the face rotation angle corresponding to the first rotation axis and a second predetermined coefficient as a correction angle; and
determining a product of an opposite number of the correction angle and the first predetermined coefficient as a component of the rotation control vector in a third dimension.

Based on the first to fourth examples according to the first aspect, in an eleventh example according to the first aspect, the motion further comprises translational motion, and controlling motion of the virtual object through the rotation control vector comprises:
determining a motion vector of the virtual object according to the rotation control vector and a current motion velocity of the virtual object; and
determining a position of the virtual object after the translational motion through the motion vector.

In a first example according to a second aspect, an embodiment of the present disclosure provides an apparatus for controlling motion of a virtual object, comprising:
a control vector generating module configured to generate a rotation control vector according to a rotation state of a face of a user in a real three-dimensional space, the rotation state comprises a face rotation angle corresponding to a rotation of the face about at least one rotation axis in the three-dimensional space, and a component of the rotation control vector in at least one dimension is associated with the face rotation angle corresponding to the rotation axis; and
a motion control module configured to control motion of the virtual object through the rotation control vector, the motion comprises rotational motion.

Based on the first example according to the second aspect, in a second example according to the second aspect, the motion control module is further configured to:
convert the rotation control vector into a first rotation parameter, the first rotation parameter is used for representing a rotation policy through a predetermined number of first sub-parameters, and the predetermined number is greater than the number of dimensions of the rotation control vector;
obtain a second rotation parameter of the virtual object, the second rotation parameter is used for representing a current orientation of the virtual object by means of the predetermined number of second sub-parameters;
determine a first angle between the first rotation parameter and the second rotation parameter; and
control the virtual object to perform rotational motion through the first angle.

Based on the second example according to the second aspect, in a third example according to the second aspect, both the first rotation parameter and the second rotation parameter are quaternions.

Based on the third example according to the second aspect, in a fourth example according to the second aspect, the motion control module is further configured to:
determine a minimum value of the first angle and a maximum character rotation angle between two adjacent frame images as a second angle;
perform an interpolation operation on the first quaternion and the second quaternion through the second angle, to obtain a corresponding third quaternion; and
control the virtual object to perform rotational motion through the third quaternion.

Based on the first to fourth examples according to the second aspect, in a fifth example according to the second aspect, the motion control module is further configured to:
in response to that a modulus of the rotation control vector is greater than or equal to a predetermined threshold, control motion of the virtual object through the rotation control vector.

Based on the fifth example according to the second aspect, in a sixth example according to the second aspect, the motion control module is further configured to:
perform unitized processing on the rotation control vector, and control motion of the virtual object through the rotation control vector after the unitized processing.

Based on the first to fourth examples according to the second aspect, in a seventh example according to the second aspect, the control vector generating module is further configured to:
obtain a face rotation angle corresponding to the first rotation axis and the second rotation axis respectively, the first rotation axis is a rotation axis located on a horizontal plane and parallel to a screen, and the second rotation axis is a rotation axis located in a vertical direction;
determine a component of the rotation control vector in a third dimension according to the face rotation angle corresponding to the first rotation axis, the third dimension is in a vertical direction;
determine the face rotation angle corresponding to the second rotation axis as a component of the rotation control vector in a first dimension, the first dimension is in a horizontal direction; and set a component of the rotation control vector in a second dimension to zero.

Based on the seventh example according to the second aspect, in an eighth example according to the second aspect, the control vector generating module is further configured to:
determine a component of the rotation control vector in a third dimension according to an opposite number of the face rotation angle corresponding to the first rotation axis.

Based on the eighth example according to the second aspect, in a ninth example according to the second aspect, the control vector generating module is further configured to:
determine a component of the rotation control vector in a third dimension through a first predetermined coefficient and an opposite number of the face rotation angle corresponding to the first rotation axis, the first predetermined coefficient is used to adjust the control sensitivity in the third dimension.

Based on the ninth example according to the second aspect, in a tenth example according to the second aspect, the control vector generating module is further configured to:
determine a sum of the face rotation angle corresponding to the first rotation axis and a second predetermined coefficient as a correction angle; and
determine a product of an opposite number of the correction angle and the first predetermined coefficient as a component of the rotation control vector in a third dimension.

Based on the first to fourth examples according to the second aspect, in an eleventh example according to the second aspect, the motion further comprises translational motion, and the motion control module is further configured to:
determine a motion vector of the virtual object according to the rotation control vector and a current motion velocity of the virtual object; and
determine a position of the virtual object after the translational motion through the motion vector.

In a third aspect, an electronic device is provided according to one or more embodiments of the present disclosure, which comprises: at least one processor and a memory;
the memory stores computer-executed instructions;
the at least one processor executes the computer-executed instructions stored in the memory to cause the electronic device to implement the method according to the first aspect.

In a fourth aspect, a computer readable storage medium is provided according to one or more embodiments of the present disclosure, which stores computer-executed instructions thereon. The computer-executed instructions, when executed by a processor, cause a computing device to implement the method according to the first aspect.

In a fifth aspect, a computer program is provided according to one or more embodiments of the present disclosure, which is for implementing the method according to the first aspect.

In a sixth aspect, a computer program product is provided according to one or more embodiments of the present disclosure, which comprises a computer program for implementing the method according to the first aspect.

The embodiments of the present disclosure provide a method and device for controlling motion of a virtual object. The method comprises: generating a rotation control vector according to a rotation state of a face of a user in a real three-dimensional space, the rotation state comprises a face rotation angle corresponding to a rotation of the face about at least one rotation axis in the three-dimensional space, and a component of the rotation control vector in at least one dimension is associated with the face rotation angle corresponding to the rotation axis; and controlling motion of the virtual object through the rotation control vector, the motion comprises rotational motion. According to the embodiments of the present disclosure, a virtual object can be controlled to perform rotational motion through a rotation state of a face of a user, so as to improve the experience of motion control on the virtual object.

The foregoing description merely illustrates the preferable embodiments of the present disclosure and used technical principles. Those skilled in the art should understand that the scope of the present disclosure is not limited to technical solutions formed by specific combinations of the foregoing technical features and also cover other technical solution formed by any combinations of the foregoing or equivalent features without departing from the concept of the present disclosure, such as a technical solution formed by replacing the foregoing features with the technical features disclosed in the present disclosure (but not limited to) with similar functions.

In addition, although various operations are depicted in a particular order, this should not be construed as requiring that these operations be performed in the particular order shown or in a sequential order. In a given environment, multitasking and parallel processing may be advantageous. Likewise, although the above discussion contains several specific implementation details, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or method logical acts, it is to be understood that the subject matter defined in the appended claims is not necessarily limited to the specific features or acts described above. On the contrary, the specific features and acts described above are merely example forms of implementing the claims.

1. A method for controlling motion of a virtual object, comprising:
generating a rotation control vector according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; and
controlling motion of the virtual object through the rotation control vector, the motion comprising rotational motion.

2. The method of claim 1, wherein controlling the motion of the virtual object through the rotation control vector comprises:
converting the rotation control vector into a first rotation parameter, the first rotation parameter being used for representing a rotation policy through a predetermined number of first sub-parameters, and the predetermined number being greater than the number of dimensions of the rotation control vector;
obtaining a second rotation parameter of the virtual object, the second rotation parameter being used for representing a current orientation of the virtual object by means of the predetermined number of second sub-parameters;
determining a first angle between the first rotation parameter and the second rotation parameter; and
controlling the virtual object to perform rotational motion through the first angle.

3. The method of claim 2, wherein both the first rotation parameter and the second rotation parameter are quaternions.

4. The method of claim 2, wherein controlling the virtual object to perform the rotational motion through the first angle comprises:
determining a minimum value of the first angle and a maximum character rotation angle between two adjacent frame images as a second angle;
performing an interpolation operation on the first quaternion and the second quaternion through the second angle, to obtain a corresponding third quaternion; and
controlling the virtual object to perform rotational motion through the third quaternion.

5. The method of claim 1, wherein controlling the motion of the virtual object through the rotation control vector comprises:
in response to a determination that a modulus of the rotation control vector is greater than or equal to a predetermined threshold, controlling the motion of the virtual object through the rotation control vector.

6. The method of claim 1, wherein controlling the motion of the virtual object through the rotation control vector comprises:
performing unitized processing on the rotation control vector, and controlling the motion of the virtual object through the rotation control vector after the unitized processing.

7. The method of claim 1, wherein generating the rotation control vector according to the rotation state of the face of the user in the real three-dimensional space comprises:
obtaining face rotation angles corresponding to the first rotation axis and the second rotation axis respectively, the first rotation axis being a rotation axis located on a horizontal plane and parallel to a screen, and the second rotation axis being a rotation axis located in a vertical direction;
determining a component of the rotation control vector in a third dimension according to the face rotation angle corresponding to the first rotation axis, the third dimension being in a vertical direction;
determining the face rotation angle corresponding to the second rotation axis as a component of the rotation control vector in a first dimension, the first dimension being in a horizontal direction; and
setting a component of the rotation control vector in a second dimension to zero.

8. The method of claim 7, wherein determining the component of the rotation control vector in the third dimension according to the face rotation angle corresponding to the first rotation axis comprises:
determining a component of the rotation control vector in a third dimension according to an opposite number of the face rotation angle corresponding to the first rotation axis.

9. The method of claim 8, wherein determining the component of the rotation control vector in the third dimension according to the opposite number of the face rotation angle corresponding to the first rotation axis comprises:
determining a component of the rotation control vector in a third dimension through a first predetermined coefficient and an opposite number of the face rotation angle corresponding to the first rotation axis, the first predetermined coefficient being used to adjust the control sensitivity in the third dimension.

10. The method of claim 9, wherein determining the component of the rotation control vector in the third dimension through the first predetermined coefficient and the opposite number of the face rotation angle corresponding to the first rotation axis comprises:
determining a sum of the face rotation angle corresponding to the first rotation axis and a second predetermined coefficient as a correction angle; and
determining a product of an opposite number of the correction angle and the first predetermined coefficient as a component of the rotation control vector in a third dimension.

11. The method of claim 1, wherein the motion further comprises translational motion, and controlling the motion of the virtual object through the rotation control vector comprises:
determining a motion vector of the virtual object according to the rotation control vector and a current motion velocity of the virtual object; and
determining a position of the virtual object after the translational motion through the motion vector.

12. (canceled)

13. An electronic device, comprising: at least one processor and a memory;
the memory storing computer-executed instructions;
the at least one processor executing the computer-executed instructions stored in the memory to cause the electronic device to implement a method for controlling motion of a virtual object, comprising:
generating a rotation control vector according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; and
controlling motion of the virtual object through the rotation control vector, the motion comprising rotational motion.

14-16. (canceled)

17. The device of claim 13, wherein controlling the motion of the virtual object through the rotation control vector comprises:
converting the rotation control vector into a first rotation parameter, the first rotation parameter being used for representing a rotation policy through a predetermined number of first sub-parameters, and the predetermined number being greater than the number of dimensions of the rotation control vector;
obtaining a second rotation parameter of the virtual object, the second rotation parameter being used for representing a current orientation of the virtual object by means of the predetermined number of second sub-parameters;
determining a first angle between the first rotation parameter and the second rotation parameter; and
controlling the virtual object to perform rotational motion through the first angle.

18. The device of claim 17, wherein both the first rotation parameter and the second rotation parameter are quaternions.

19. The device of claim 17, wherein controlling the virtual object to perform the rotational motion through the first angle comprises:
determining a minimum value of the first angle and a maximum character rotation angle between two adjacent frame images as a second angle;
performing an interpolation operation on the first quaternion and the second quaternion through the second angle, to obtain a corresponding third quaternion; and
controlling the virtual object to perform rotational motion through the third quaternion.

20. The device of claim 13, wherein controlling the motion of the virtual object through the rotation control vector comprises:
in response to a determination that a modulus of the rotation control vector is greater than or equal to a predetermined threshold, controlling the motion of the virtual object through the rotation control vector.

21. The device of claim 13, wherein controlling the motion of the virtual object through the rotation control vector comprises:
performing unitized processing on the rotation control vector, and controlling the motion of the virtual object through the rotation control vector after the unitized processing.

22. The device of claim 13, wherein generating the rotation control vector according to the rotation state of the face of the user in the real three-dimensional space comprises:
obtaining face rotation angles corresponding to the first rotation axis and the second rotation axis respectively, the first rotation axis being a rotation axis located on a horizontal plane and parallel to a screen, and the second rotation axis being a rotation axis located in a vertical direction;
determining a component of the rotation control vector in a third dimension according to the face rotation angle corresponding to the first rotation axis, the third dimension being in a vertical direction;
determining the face rotation angle corresponding to the second rotation axis as a component of the rotation control vector in a first dimension, the first dimension being in a horizontal direction; and
setting a component of the rotation control vector in a second dimension to zero.

23. The device of claim 22, wherein determining the component of the rotation control vector in the third dimension according to the face rotation angle corresponding to the first rotation axis comprises:
determining a component of the rotation control vector in a third dimension according to an opposite number of the face rotation angle corresponding to the first rotation axis.

24. A non-transitory computer readable storage medium, wherein the computer readable storage medium stores computer-executed instructions which, when executed by a processor, cause a computing device to implement a method for controlling motion of a virtual object, comprising:
generating a rotation control vector according to a rotation state of a face of a user in a real three-dimensional space, the rotation state comprising a face rotation angle corresponding to a rotation of the face about at least one rotation axis in the three-dimensional space, and a component of the rotation control vector in at least one dimension being associated with the face rotation angle corresponding to the rotation axis; and
controlling motion of the virtual object through the rotation control vector, the motion comprising rotational motion.
